(19) United States
(12) Patent Application Publication
(10) Pub. No.: US 2022/0407399 A1
(43) Pub. Date: Dec. 22, 2022

(54) DEVICE FOR CUTTING TO LENGTH CONDUCTOR PIECES RECEIVED IN A STATOR CORE

(71) Applicant: Gehring Technologies GmbH + Co. KG, Ostfildern (DE)

(72) Inventor: Christoph Bäder, Altbach (DE)

(73) Assignee: Gehring Technologies GmbH + Co. KG, Ostfildern (DE)

(21) Appl. No.: 17/776,409

(22) PCT Filed: Nov. 12, 2020
(86) PCT No.: PCT/EP2020/081856

§ 371 Date: May 12, 2022

(30) Foreign Application Priority Data
Nov. 12, 2019 (DE) 10 2019 130 533.0

(51) Int. Cl. H02K 15/00; B23D 15/10; H02K 15/06; B21F 11/00; B23D 15/14

(52) U.S. Cl. CPC H02K 15/0037; B23D 15/10; H02K 15/064; B21F 11/00; B23D 15/14; H02K 2213/03

(57) ABSTRACT

The invention relates to a device for cutting to length conductor pieces, in particular hairpins, received in a stator core, including a receptacle for the stator core together with the conductor pieces received therein, the free ends of which protrude out of the stator core when in the received state, in particular in the direction of gravity, and a cutting unit which comprises cutting portions that are designed and arranged such that they can be moved toward one another in order to act in a cutting manner from two opposing sides on at least one conductor piece to be cut to length, and the longitudinal axis thereof, during a cutting process.

### BACKGROUND

The invention relates to a device for cutting to length conductor pieces which are received in a stator core.

With the so-called hairpin technology, conductor pieces that are hairpin-shaped in the broadest sense are used together with individual special pins of different types in a stator core. Hairpins are thus conductor pieces having essentially two extended legs and a connecting portion connecting these two legs. The multiplicity of conductor pieces is usually arranged in such a way that the conductor pieces are arranged in rows, each of which extends in a radial direction, on a plurality of circular paths running in a circumferential direction. The free ends of the legs protrude from the stator core on one side thereof, and the connecting portions are arranged on the other side of the stator core.

After being inserted, the free ends are contorted or bent in the circumferential direction, this step also being referred to as “twisting”. In the process, individual hairpins (generally conductor pieces or their free ends) are twisted clockwise and others counterclockwise in the circumferential direction. Typically, the free legs of the hairpins, the conductor pieces, are twisted in such a way that, after twisting, they are arranged in a directly adjacent row or the next row over (it is also conceivable that further rows are skipped) or they are arranged between two original rows with other conductor pieces from rows that originally were different. The twisting is carried out, for example, by means of cylinders which are arranged concentrically to one another and are rotatable, where conductor pieces, which are arranged on a circular path, are each received in corresponding receptacles in a cylinder. Twisting the cylinders relative to each other bends the conductor pieces onto adjacent circular paths, for example in different directions.

Before twisting, it may be desirable to bend the hairpins radially outward.

After twisting, the hairpins are usually cut to length (shortened to a specified length), and then certain hairpins/conductor pieces or their free ends are welded together in order to form the windings of the stator. In order to shorten the hairpins and mask them for the welding process (this prevents hot material from entering the stator), a plate-like cover with recesses is often placed over the free ends so that the free ends are located in the recesses. When cutting to length, the free ends protruding beyond the cover are then cut off using a planer.

It is the object of the invention to provide a device for cutting to length conductor pieces, in particular hairpins, received in a stator core, which device carries out this process as precisely as possible and with minimal risk of damage to the conductor pieces.

### SUMMARY OF THE INVENTION

The object is achieved by a device according to claim 1, wherein the device comprises:

a receptacle for receiving a stator core and the conductor pieces received therein. In the received state, the free ends of the conductor pieces arranged in the stator core protrude from the stator core.

At least one cutting unit having at least two cutting portions. The cutting portions can be moved here reversibly toward one another in order to be able to carry out a cutting process. To carry out a cutting process, the cutting portions act from two opposite sides on at least one conductor piece and its longitudinal axis, or on a free end of at least one conductor piece and its longitudinal axis.

If a conductor piece is cut to length using the cutting unit, the result after the cutting process is a cut edge that lies within the cross section of the conductor piece. If a plurality of conductor pieces arranged in a row are cut to length using the cutting unit, the result after the cutting process is a cut edge that lies within the cross section of the conductor pieces that were cut to length. Thus, burr formation on the outside of a conductor piece or a conductor piece row can be prevented. This is particularly advantageous during the subsequent welding process. In addition, a possible risk of injury on such a burr is prevented.

Because the cutting movement of the cutting portions acts on the conductor piece or the row of conductor pieces from two opposite sides, the lateral applications of force on the conductor piece or the row of conductor pieces cancel each other out. This prevents a one-sided application of force on the conductor piece or the conductor piece row. A possible, unintentional bending of the conductor pieces due to a one-sided application of force or an application of force that is asymmetrical with respect to the longitudinal axis is avoided.

A one-sided application of force would also be transmitted to the receptacle via the conductor pieces and the stator core. The receptacle would therefore have to be designed in such a way that it withstands this one-sided application of force and holds the stator core securely and stably in its alignment. This is structurally complex because, for example, additional stabilizing elements have to be attached. Because the one-sided application of force is avoided by the two cutting portions of the cutting unit which can be moved relative to one another, the receptacle can be made structurally simpler and/or more compact.

It is conceivable that the cutting unit has a plurality of cutting portions that are configured in pairs (that is, two, four, six, eight, etc.). The fact that two cutting portions interact during the cutting process results in the above-described advantages with regard to burr formation and the one-sided application of force.

The conductor pieces are preferably arranged in rows in the stator core. These conductor piece rows are arranged on circular paths running in a circumferential direction of the stator core and extend along a radial direction of the stator core. The free ends of the conductor pieces protruding from the stator core extend along a longitudinal direction of the stator core that corresponds in particular to the direction of gravity. In particular, cut-off conductor piece parts can fall off in the direction of gravity, i.e., away from the stator core. They therefore do not get into the stator core, where they represent a defect, cause a short circuit and/or damage the stator core, for example due to an impact.

At least one cutting unit is designed and arranged in such a way that the cutting portions are moved along the radial direction when a cutting process is carried out. In this way, a plurality of cutting units can be arranged in a star shape about the stator core, and they can carry out a cutting process at the same time. The overall process of cutting to length can thus be accelerated.

At least one cutting unit can be designed and arranged in such a way that the cutting portions are moved along a direction orthogonal to the radial direction when a cutting process is carried out. The direction orthogonal to the radial direction corresponds to a tangent to the circular path around the center point of the stator core, on which tangent the at least one conductor piece to be cut to length is arranged. In this way, individual or multiple conductor pieces which are located within a conductor piece row, i.e., represent neither the outermost nor the innermost conductor piece of such a conductor piece row, can also be cut to length. It is thus possible to cut conductor pieces to different lengths within the same row of conductor pieces.

More preferably, the cutting unit can comprise two cutting arms. These are pivotally mounted in a common cutting pivot point and connected to each other therein. Each cutting arm has a cutting portion on a first side and each cutting arm has an extension arm on a second side opposite the first side. In addition, the cutting unit has a positioning arm with which the cutting portions can be brought into a working position. The cutting pivot point has a stationary arrangement relative to the positioning arm.

Advantageously, the cutting unit can comprise two actuating arms. These are connected to one another at a pivot point and are pivotable about a common actuating arm pivot point. The pivot point thus corresponds to the actuating arm pivot point. The pivot point is arranged in particular in the region of a respective first end of the respective actuating arm. Each actuating arm is operatively connected to an actuating unit at its respective second end. The actuating unit can move the second ends of the actuating arms back and forth relative to one another, so that the actuating arms can be pivoted relative to one another about the pivot point or actuating arm pivot point. One cutting arm is connected to one of the actuating arms at a connection point. Each cutting arm can pivot about its connection point relative to the actuator arm.

The pivot point, i.e., the actuating arm pivot point, is guided in the positioning arm with a translational degree of freedom. in other words, the actuating arm pivot point can be moved along the degree of freedom with respect to the positioning arm, which is used to position the cutting unit with respect to the stator. However, it cannot be moved freely, i.e., not outside the one degree of freedom.

According to an advantageous embodiment, the actuating unit is designed as a pressure cylinder, hydraulic cylinder, pneumatic cylinder or the like. However, an actuating unit based on a different principle, such as electrical, magnetic, electromechanical, etc. is also conceivable.

Because of the translational degree of freedom, the pivot point can preferably be moved back and forth on a straight line in relation to the positioning arm and in particular within the positioning arm. The straight line along which the pivot point can be moved runs, in particular, through the pivot point and the cutting pivot point. The pivot axis of the pivot point can be guided within an elongated hole in the positioning arm. During the back-and-forth movement of the pivot point, the distance between the pivot point and the cutting pivot point decreases or increases, because the cutting pivot point is fixed with respect to the positioning arm.

Each connection point on an actuating arm is preferably arranged between the pivot point and a point at which the respective actuating arm is connected to the actuating unit. In other words, the connection point is located on the particular actuating arm between the first end and the second end of the actuating arm. In each connection point, a cutting arm is articulated in a pivotably mounted manner on the corresponding actuating arm.

According to an advantageous embodiment, the stator core within the receptacle can be rotated relative to the cutting unit along the circumferential direction (can be rotated in the receptacle or the receptacle can be rotated together with the stator core). However, the cutting unit can also be moved along the circumferential direction and/or radial direction (via the positioning arm). A superimposition of both movements, rotation of the stator core and movement of the cutting unit, is also conceivable. After each cutting process, the stator core and/or the cutting unit can be moved so that the cutting unit is brought into a position in which the next conductor piece or the next row of conductor pieces can be cut to length. With an arrangement of a plurality of cutting units radially and/or tangentially to the stator core, all desired conductor pieces can be reached by a cutting unit and cut to the desired length with just a few movement steps (rotation of the stator core and/or movement of a cutting unit). This speeds up the overall cutting process.

The cutting arms can each have an attachment portion. The attachment portion extends between the cutting arm and cutting pivot point. The cutting portion and extension arm of a cutting arm are on the same side of a straight line passing through the pivot point and cutting pivot point. This is the case when the cutting unit is in an open and/or closed state.

More preferably, the cutting unit is chamfered in the region of the cutting portions. The cutting unit can also be chamfered in the region of a straight line that runs through the pivot point and the cutting pivot point. However, the cutting unit can also be chamfered overall. The chamfers are oriented in such a way that there are no (horizontal) planar surfaces that are perpendicular to the force of gravity, or at least such planar surfaces are largely avoided. Parts that fall off (in the direction of gravity), such as cut-off conductor piece parts, can slide along the chamfers and fall off the cutting unit. It can thereby be ensured that falling or cut-off parts do not remain on the cutting unit and, for example, become jammed in the cutting unit during a subsequent cutting process and/or movement process. As a result, the cleaning effort and the maintenance effort of the device or the cutting unit can be reduced.

More preferably, the cutting unit is designed in such a way that a connecting straight line, which connects the cutting portions that face one another, and a straight line parallel thereto through the pivot point are arranged at a distance from one another. The distance between the connecting straight line and the straight line through the pivot point is greater in the closed state of the cutting unit than in the open state of the cutting unit. Thus, the cutting unit does not have to be retracted after the cutting process, because the cutting portions move away from the cut conductor piece when the cutting unit is in the open state. Accordingly, during a cutting process, the cutting portions move toward one another and toward the conductor piece to be cut to length or toward the stator core. In other words, the cutting portions move along the longitudinal direction during a cutting process while the positioning arm is held stationary.

After the cutting process, the cutting unit can therefore be moved to the next conductor piece or the next row of conductor pieces without moving away from the conductor piece or the row of conductor pieces along the longitudinal direction (or before the cutting process without moving toward the conductor piece or the row of conductor pieces along the longitudinal direction). However, the movements of the cutting unit can at least be reduced during one or more cutting processes along the longitudinal direction. This reduces the total number of movements required in the overall cutting process and speeds it up.

The positioning arm, the actuating unit, the cutting arms and/or the actuating arms are preferably arranged essentially in one plane. Such an arrangement leads to a compact and, in particular, narrow construction of the cutting unit. In particular, a plurality of cutting units can be arranged radially (star-shaped) and/or tangentially on a stator core to save space.

It is provided according to the invention that an actuating unit, which is designed as a hydraulic or pneumatic cylinder, moves the cutting portions toward one another by means of an extension movement (lengthening of the actuating unit or extension of a piston out of a cylinder) and moves them away from each other by means of a retraction movement (shortening of the actuating unit or retraction of a piston into a cylinder).

### BRIEF DESCRIPTION OF THE DRAWINGS

Further features, details and advantages of the invention can be found in the wording of the claims and in the following description of the embodiment with reference to the drawings, in which:

FIG. 1 is a side view of a cutting unit in the open state;

FIG. 2 is a perspective view of the cutting unit according to FIG. 1;

FIG. 3 is a side view of the cutting unit in the closed state;

FIG. 4 is a perspective view of the cutting unit according to FIG. 3;

FIG. 5 is a top view of the cutting unit according to FIG. 3 and

FIG. 6 is a perspective view of an arrangement of a plurality of cutting units.

### DETAILED DESCRIPTION

In the following description and in the figures, corresponding components and elements have the same reference signs. For the sake of clarity, not all of the reference signs are shown in all of the figures.

The device 10 for cutting to length conductor pieces 14 received in a stator core 12 has a receptacle for the stator core 12 and at least one cutting unit 16.

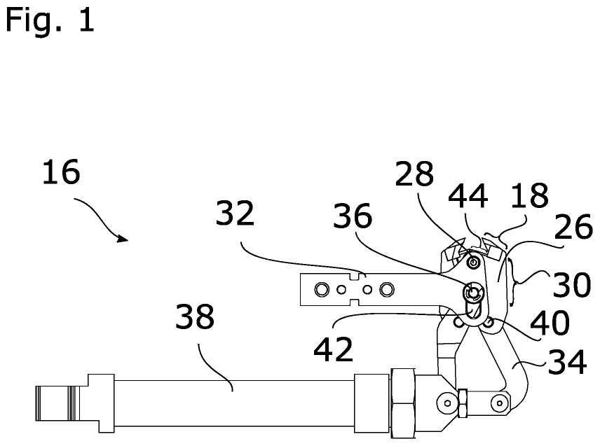

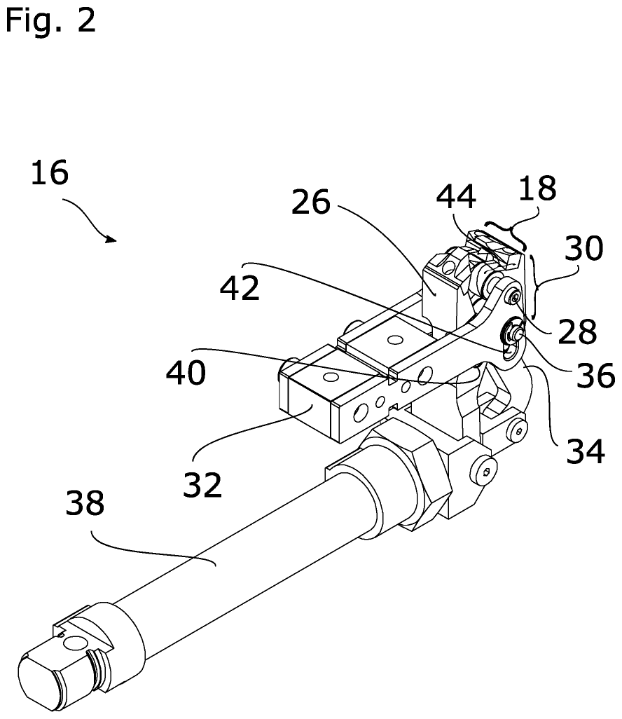

A side view of the cutting unit 16 in the open state is shown in FIG. 1. FIG. 2 shows a perspective view of the cutting unit 16 according to FIG. 1.

The cutting unit 16 has two cutting portions 18. These can be moved toward and away from one another to carry out a cutting process. One conductor piece 14 or a plurality of conductor pieces 14 can be cut to a desired length via a cutting process by cutting off a part of the conductor piece 14.

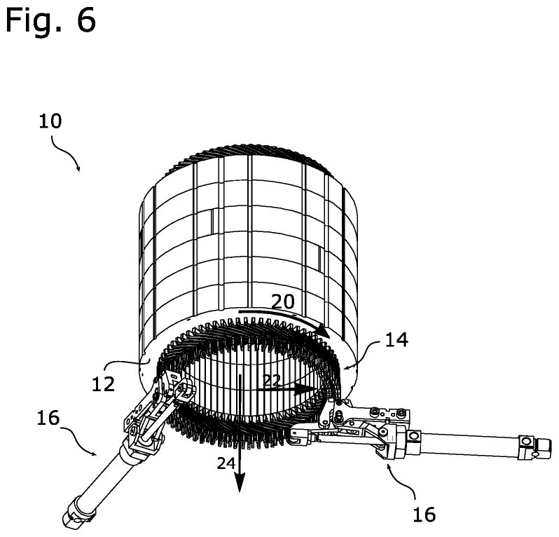

The conductor pieces 14 to be cut to length are arranged in rows, each of which extends in a radial direction 22, along circular paths running in a circumferential direction 20. The free ends of the conductor pieces 14 which are to be cut to length protrude from the stator core 12 along a longitudinal direction 24 (see FIG. 6).

The cutting unit 16 also includes two cutting arms 26. These are each mounted pivotably via an attachment portion 44 in a common cutting pivot point 28 and are connected to one another. Each cutting arm 26 has the cutting portion 18 on its first side and an extension arm 30 on its second side, opposite the first side.

The cutting unit 16 has a positioning arm 32. With the positioning arm 32, the cutting unit 16 and in particular the cutting portions 18 can be moved into a working position in which a cutting process can be carried out.

The cutting arms 26 are pivoted about the cutting pivot point 28 by means of two actuating arms 34.

The two actuating arms 34 are each connected to one another at a first end in a pivot point 36 and are pivotably mounted about this point. The pivot point 36 thus represents the actuating arm pivot point of the two actuating arms 34. The pivot point 36 or its pivot axis is guided within an elongated hole 42 which is arranged in the positioning arm 32.

The two actuating arms 34 are each operatively connected to an actuating unit 38 at a second end. In this embodiment, the actuating unit 38 is designed in the form of a pneumatic cylinder. It can also be provided that the actuating unit 38 is operatively connected directly to the cutting arms 26 without the interposition of the actuating arms 34 which, however, form a lever transmission for the actuating unit 38. In this case, it is provided in particular that the extension arms 30 are virtually crossed over the cutting pivot point 28, so that the actuating unit 38, which is designed as a hydraulic cylinder, moves the cutting portions 18 toward one another by means of an extension movement.

In general, it is provided according to the invention that an actuating unit 38, which is designed as a hydraulic or pneumatic cylinder, moves the cutting portions 18 toward one another by means of an extension movement (lengthening of the actuating unit or extension of a piston from a cylinder) and moves them away from each other by means of a retraction movement (shortening of the actuating unit or retraction of a piston into a cylinder).

The cutting arms 26 are each connected to the actuating arms 34 at a connection point 40 and are pivotably mounted about this connection point 40.

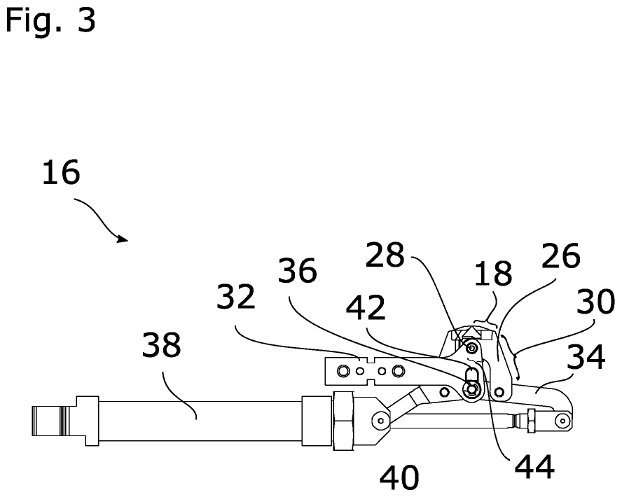

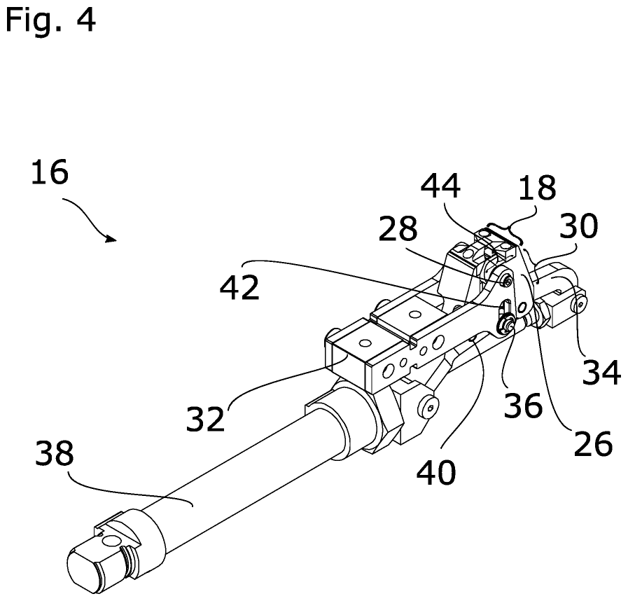

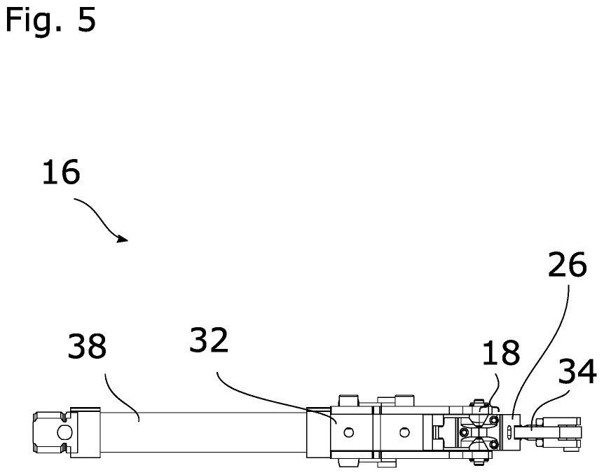

To carry out a cutting process, the cutting unit 16 is transferred from the open state shown in FIG. 1 and FIG. 2 to a closed state. In FIGS. 3 to 5, the cutting unit 16 is shown in a closed state, wherein FIG. 3 shows a side view, FIG. 4 a perspective view and FIG. 5 a top view of the cutting unit 16.

The cutting process is carried out by the actuating unit 38 moving the two second ends of the actuating arms 34 apart in a relative movement when the cutting unit 16 is in the open state. During this relative movement of the actuating arms 34, the pivot point 36 moves within the elongated hole 42 from a first end of the elongated hole 42, in which the pivot point 36 is located when the cutting unit 16 is in the open state (see FIG. 1), to a second end of the elongated hole 42, in which the pivot point 36 is located when the cutting unit 16 is in the closed state (see FIG. 3). The pivot point 36 moves effectively within the elongated hole 42 in FIG. 1 from top to bottom.

The relative movement of the actuating arms 34 forces the two connection points 40 apart. The pivoting process of the cutting arms 26 is thus initiated. In the process, the cutting arms 26 move about the cutting pivot point 28, so that the cutting portions 18 move toward one another until the closed state of the cutting unit 16 shown in FIGS. 3 to 5 is reached.

Due to a double translation of the force achieved in this way, namely via the actuating arms 34 and the cutting arms 26, a comparatively small force of the actuating unit 38 is required in order to achieve a comparatively high cutting force of the cutting portions 18. Because the actuating unit 38 has to apply less force, it can be made smaller or more compact.

The cutting unit 16 is opened analogously by the actuating unit 38 moving the two second ends of the actuating arms 34 back together in a relative movement. The pivot point 36 moves along the elongated hole 42 in FIG. 3 from bottom to top. The connection points 40 move toward each other and the cutting arms 26 pivot apart about the cutting pivot point 28 so that the cutting portions 18 move away from each other.

The movement of the cutting portions 18 is a superimposition of movements in two directions running perpendicular to one another. On the one hand, the cutting portions 18 move toward one another and back away from one another. On the other hand, due to the mechanics shown and the movement apparatus, the cutting portions 18 also move parallel to a straight line that runs through the pivot point 16 and the cutting pivot point 28. Thus, during the cutting process, the cutting portions 18 move toward the conductor piece 14 (or plurality of conductor pieces 14) to be cut to length or the stator core 12 and, after the cutting process, move away from the conductor piece 14 (or plurality of conductor pieces 14) that has been cut to length or the stator core 12 when the cutting unit 16 is opened.

In the illustrated embodiment, the cutting unit 16 has various inclined surfaces. For example, the cutting portions 18 are partially chamfered, as can be seen in particular in FIGS. 2, 4 and 5. Possible falling parts, e.g., cut-off conductor piece parts, should slide off the inclined surfaces and fall on the cutting unit 16 and/or through the cutting unit 16. They should not stick to or be left on the cutting unit 16, so that the function, and in particular the movement apparatus of the cutting unit 16, is not disturbed or even damaged.

FIG. 6 shows a perspective view of an arrangement of a plurality of cutting units 16. Due to the fact that the cutting unit 16 has a compact design and in particular a narrow design, a plurality of cutting units 16 can be arranged about the stator core 12 in a space-saving manner.

A first cutting unit 16 is arranged along the radial direction 22. The cutting portions 18 of the first cutting unit 16 therefore likewise move in the radial direction. In this way, a conductor piece 14 but also a complete row of conductor pieces extending in the radial direction can be cut to length via a single cutting process.

A second cutting unit 16 is oriented perpendicularly to the first cutting unit 16, i.e., perpendicularly to the radial direction 22 (tangential orientation). The cutting portions 18 of the second cutting unit 16 thus also move perpendicular to the radial direction (tangential to the circumferential direction 20). A conductor piece 14 or a plurality of conductor pieces 14 can thus be cut to length, in particular within a radially extending row of conductor pieces. For example, conductor pieces 14 can be cut to different lengths within the same row of conductor pieces.

1. Device for trimming conductor pieces inserted in a stator core, comprising:
a. a seat for the stator core with the conductor pieces inserted therein, the free ends of which protrude from the stator core in the inserted condition,
b. and at least one trimming unit which comprises at least two blade sections which are configured and arranged in such a way that they can be moved towards one another to act in a cutting manner during a cutting process from two opposite sides upon at least one conductor piece to be trimmed and its longitudinal axis characterized in that the trimming unit comprises two cutting arms which are connected to one another pivotably supported at a common blade pivot point, wherein the blade arms each have on a first side one of the blade sections and on a second side opposite to the blade section an extension arm as well as a positioning arm, by means of which the blade sections can be brought in an operating position, wherein the blade pivot point has a fixed position with respect to the positioning arm.

2. (canceled)

3. (canceled)

4. Device according to claim 1, characterized in that the trimming unit further comprises: two operating arms which are arranged each supported pivotably around a common operating arm pivot point and connected to one another at a linkage point which is situated in the area of a respective first end of the respective operating arm, and which are operatively connected with their respective second end to an actuating unit, wherein the actuating unit is configured to move the second ends of the operating arms relative to one another and thus to pivot the operating arms around the operating arm pivot point against each other, wherein each blade arm is linked pivotably supported to a respective operating arm at a linkage point, and the linkage point is guided in the positioning arm with a translational degree of freedom.

5. Device according to claim 4, characterized in that the actuating unit is in the form of a pressure, hydraulic or pneumatic cylinder.

6. Device according to claim 4, characterized in that the translational degree of freedom of the linkage point allows a sliding of the linkage point with respect to the positioning arm along a straight line extending through the linkage point and the blade pivot point, wherein a pivot axis of the linkage point is guided in an oblong hole of the positioning arm.

7. Device according to claim 4, characterized in that the linkage point where a respective blade arm is linked pivotably supported to the respective operating arm, is each arranged along the extension of the respective operating arm between the linkage point and a point of operative connection with the actuating unit.

8. Device according to claim 1, characterized in that the stator core is rotatable in the seat with respect to the trimming unit along the circumferential direction, and/or the trimming unit is movable along the circumferential direction and/or radial direction.

9. Device according to claim 3, characterized in that the blade arms each comprise a mounting section extending to the blade pivot point where they are linked to the blade pivot point, wherein the blade section and the extension arm of the same blade arm are arranged on the same side with respect to the straight line extending through the linkage point and the blade pivot point, when the trimming unit is in its open state, and/or wherein the blade section and the extension arm of the same blade arm are arranged on the same side with respect to the straight line which extending through the linkage point and the blade pivot point, when the trimming unit is in its closed state.

10. Device according to claim 4, characterized in that the trimming unit is beveled in the region of the blade sections in particular—in the region of a straight line extending through the linkage point and the blade pivot point and in particular everywhere in the direction of gravity, so that there are no flat surfaces extending orthogonal in relation to gravity on which bits of conductor pieces could remain.

11. Device according to claim 4, characterized in that the trimming unit is configured in such a way that a straight connecting line which connects the ends of the blade sections facing one another has a distance to a straight line extending through the linkage point and parallel to the straight connecting line, wherein the distance between the straight connecting line and the straight line through the linkage point is greater in the closed state of the trimming unit than in the is open state of the trimming unit.

12. Device according to claim 4, characterized in that the positioning arm, the actuating unit, the blade arms and/or the operating arms are arranged essentially in one plane.

13. Device as claimed in claim 1, characterized in that the conductor pieces are arranged in rows, which extend each in a radial direction, on several circuits extending in a circumferential direction, and protrude from the stator core along a longitudinal direction corresponding particularly to the direction of gravity, wherein at least one trimming unit is configured and arranged in such a way that the movement of the blade sections during a cutting operation is performed along the radial direction
and/or
at least one trimming unit (16) is configured and arranged in such a way that the movement of the blade portions (18) is performed along a direction orthogonal to the radial direction.
